(19) United States
(12) Patent Application Publication
(10) Pub. No.: US 2006/0165172 A1
(43) Pub. Date: Jul. 27, 2006

(54) Method for transmitting data without jitter in synchronous Ethernet

(75) Inventors: Jun-Ho Koh, Suwon-si (KR); Chang-Sup Shim, Seoul (KR); Jae-Hun Cho, Seoul (KR)

Correspondence Address: CHA & REITER, LLC, 210 ROUTE 4 EAST STE 103, PARAMUS, NJ, 07652, US

(73) Assignee: Samsung Electronics Co., LTD.

(21) Appl. No.: 11/336,677

(22) Filed: Jan. 20, 2006

(30) Foreign Application Priority Data
Jan. 21, 2005 (KR) 5993/2005

(51) Int. Cl. H04N 7/12; H04N 11/04; H04B 1/66; H04N 11/02

(52) U.S. Cl. 375/240.12; 375/240.28

(57) ABSTRACT

Disclosed is a method for transmitting asynchronous data in a synchronous Ethernet having a sync frame section and an async frame section. The method includes the steps of: a) allocating a priority to motion picture data for transmission through the sync frame section; b) determining if a size of the data of all frames for transmission in one cycle exceeds the predetermined length; c) dropping motion picture data having a lower priority (e.g. which corresponds to the size of the data exceeding the predetermined length); and d) transmitting the data in one cycle unit when the size of the data to be transmitted does not exceed the predetermined length.

### CLAIM OF PRIORITY

This application claims the benefit of an earlier application entitled “Method For Transmitting Data Without Jitter In Synchronous Ethernet,” filed in the Korean Intellectual Property Office on Jan. 21, 2005, and assigned Ser. No. 2005-5993, the entire contents of which are incorporated herein by reference.

### BACKGROUND OF THE INVENTION

1. Field of the Invention

The present invention relates to a method for transmitting asynchronous data in a synchronous Ethernet, and more particularly to a method for transmitting a motion picture without jitter by allocating a priority to each transmission frame of the motion picture.

2. Description of the Related Art

In general, Ethernet is a technology used when data is transmitted between different terminals or different users. The Ethernet has been known to be unsuitable for transmission of motion pictures and voice data, which are susceptible to transmission time delay. However, discussions have been made regarding technology that can transmit synchronous data, such as image and voice data, using the existing Ethernet. Such an Ethernet for transmission of synchronous data is called a synchronous Ethernet.

FIG. 1 illustrates the structure of a transmission cycle in a conventional synchronous Ethernet.

The conventional synchronous Ethernet has a transmission cycle of 125 μsec. Each transmission cycle includes a sync frame section 11 for transmission of synchronous data and an async frame section 12 for transmission of asynchronous data.

The sync frame section 11 for transmission of synchronous data contains data having the highest priority in the transmission cycle. In conventional systems, 10 sub-synchronous frames, each of which are constructed with 738 bytes, are included in the sync frame section 11 as a default value.

The async frame section 12 for transmission of the asynchronous data is configured with the remaining region, except for the region for the sync frame section 11, and contains variable asynchronous data in a unit of frame.

FIGS. 2A to 2C are views for explaining a data transmission scheme in conventional synchronous Ethernet systems.

FIG. 2A shows sync frames 201 to 205 for transmission through the sync frame section 11. FIG. 2B shows async frames 211 to 214 for transmission through the async frame section 12. Herein, it is assumed that the sync frame section 11 of one cycle contains four sync frames (e.g. sync frames 201 to 204).

FIG. 2C shows a data transmission scheme in the conventional synchronous Ethernet system. The sync frames 201 to 204 are sequentially inserted into the sync frame section 11. Then the async frames are inserted into the async frame section 12. However, as shown in FIG. 2C, when the async frames are too large to be included within a cycle of 125 μsec, the start 23 of the next cycle is delayed. In particular, when 125 μsec elapses after the start 21 of a first cycle, the end 22 of the first cycle and the start 23 of the second cycle must be performed at the same time. However, when, as shown in FIG. 2C, the end of the first cycle is delayed by a delay time 24 due to the capacity of a fourth async frame 214, the start 23 of the second cycle is delayed. When the start of a cycle is not in harmony with a prescribed unit, as described above, jitter occurs.

Therefore, it is important to match each cycle with a unit of 125 μsec. Various studies are being conducted to develop a method capable of preventing a delay due to excessive capacity of the async frame section 12, as shown in FIG. 2C.

For example, there is a hold scheme for preventing a delay due to excessive capacity of the async frame section 12.

FIGS. 3A to 3C are views for explaining a data transmission scheme employing the hold scheme in conventional synchronous Ethernet systems.

FIG. 3A shows sync frames 301 to 308 for transmission through the sync frame section 11. FIG. 3B shows async frames 311 to 315 for transmission through the async frame section 12. Herein, it is assumed that the sync frame section 11 of one cycle contains four sync frames (e.g. sync frames 301 to 304, or 305 to 308).

FIG. 3C shows a data transmission scheme employing the hold scheme in the conventional synchronous Ethernet system. The sync frames 301 to 304 are sequentially inserted into the sync frame section 11. Then the async frames are inserted into the async frame section 12. When the async frames are too large to be included within a cycle of 125 μsec, the start of the next cycle is delayed. When employing the hold scheme, the remaining space of the async frame section 12 is compared with the size of an async frame (e.g. a fourth async frame 314) to be inserted into the remaining space. If the size of an async frame to be inserted is larger than the size of the remaining space of the async frame section 12, the relevant async frame is held for transmission in the next cycle.

For example, the length of an async frame's space remaining for transmission in the first cycle is “L1”, and the length of the fourth async frame 314 to be inserted for transmission is “L2”. When the “L1” is equal to or longer than the “L2”, the fourth async frame 314 for transmission is inserted into the remaining space of the async frame section 12 and is transmitted.

In contrast, when the “L1 is shorter than the “L2”, the fourth async frame 314 for transmission cannot be inserted within the remaining space of the async frame section 12. Accordingly, the first cycle is transmitted with the remaining space of the async frame section 12 un-filled, and the fourth async frame 314 for transmission is inserted and transmitted as a first async frame of an async frame section 12 for the second cycle.

When employing the hold scheme as described above, if spare time between the present time and the start time of the next cycle is shorter than the length of an async frame to be currently transmitted, the relevant async frame is transmitted in the next cycle. In this case, each cycle is punctually started, but an empty region may be transmitted, consequently bandwidth is wasted.

### SUMMARY OF THE INVENTION

Accordingly, the present invention has been made to reduce or overcome the above-mentioned problems occurring in the prior art. One aspect of the present invention is to provide a method for transmitting data without loss of bandwidth as well as without jitter in a synchronous Ethernet system, by allocating a priority to each unit frame for the motion picture and dropping some data based on their priorities.

In accordance with one aspect of the present invention, a method is provided for transmitting data in a synchronous Ethernet system having a sync frame section and an async frame section, the method including the steps of: a) allocating a priority to motion picture data for transmission in the sync frame section; b) determining if a size of the data for all frames for transmission in one cycle exceeds a predetermined length; c) dropping motion picture data having a lower priority if the size of the data to be transmitted exceeds the predetermined length; and d) transmitting the data in one cycle unit.

### BRIEF DESCRIPTION OF THE DRAWINGS

The present invention will be more apparent from the following detailed description taken in conjunction with the accompanying drawings, in which:

FIG. 1 illustrates the structure of a transmission cycle in a conventional synchronous Ethernet;

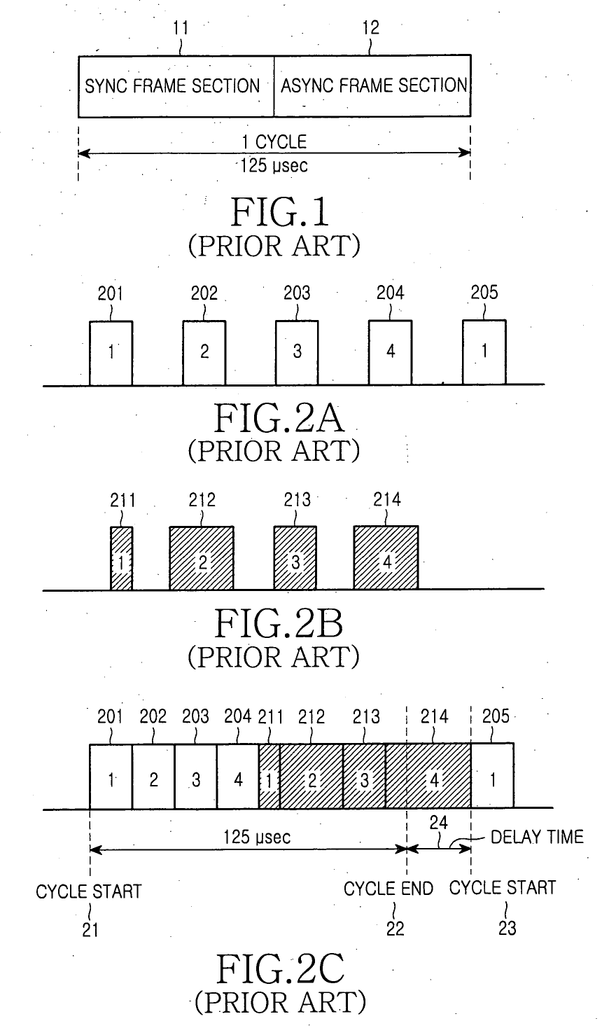

FIGS. 2A to 2C are views for explaining a data transmission scheme in a conventional synchronous Ethernet system;

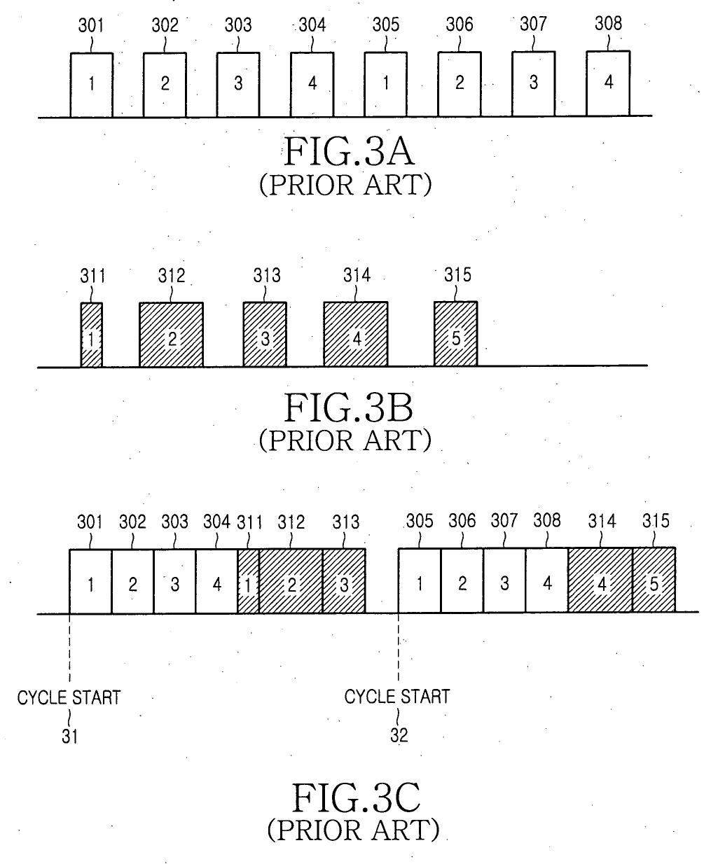

FIGS. 3A to 3C are views for explaining a data transmission scheme employing the hold scheme in the conventional synchronous Ethernet system;

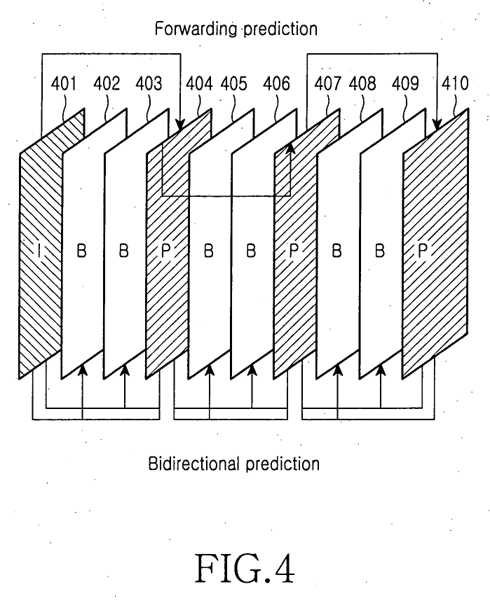

FIG. 4 illustrates a GOP of MPEG pictures;

FIGS. 5A to 5D are views for explaining a data transmission scheme without jitter in a synchronous Ethernet system according to an embodiment of the present invention; and

FIG. 6 is a flowchart illustrating a method for transmitting data without jitter in a synchronous Ethernet system according to an embodiment of the present invention.

### DETAILED DESCRIPTION

Hereinafter, an embodiment according to the present invention will be described with reference to the accompanying drawings. It is noted that the same elements are indicated with the same reference numerals throughout the drawings. For the purposes of clarity and simplicity, a detailed description of known functions and configurations incorporated herein will be omitted as it may obscure the subject matter of the present invention.

An MPEG motion-picture compression algorithm is progressed from a UPEG still-picture compression algorithm and an H.261 motion-picture compression algorithm. According to the MPEG algorithm, every frame is not compressed as its individual still picture, but resemblance between adjacent frames is used in compression. That is, prediction and interpolation are used for motion compensation.

However, the MPEG algorithm does not compress all frames by using prediction and interpolation. A frame, which can be stored with its own information, must be regularly inserted. Such a frame is compressed as a still picture similar to a frame of the JPEG algorithm.

A frame compressed as a still picture is called an intra-coded frame (I frame), a frame created by prediction is called a predictive-coded frame (P frame), and a frame created by interpolation is called a bidirectional-coded frame (B frame).

An MPEG motion picture is created by combining the three types of frames in a predetermined pattern. In detail, the I frame may be located at every position in a data stream, is used for random access to data, and is encoded without reference to other images. The I frame is compressed using a still-picture compression scheme, but is compressed in real time. Also, the I frame is compressed with the lowest compression ratio used for the MPEG.

When the P frame is encoded and is decoded, information of the prior I frame or prior P frame is used. The P frame is designed by the realization that the entire configuration of the continuous images is not changed, but image blocks are laterally shifted. That is, when there is motion in continuous images, an object is merely shifted to one side without a large change in the object itself in most cases. Therefore, considering that the difference between the prior screen and the present screen is very small, the P frame is created by encoding only difference values between the two frames.

The B frame uses all of the prior/next I and P frames when it is encoded and decoded. When the B frame is used, a relatively higher compression ratio can be obtained. The B frame has a difference value between an I or P frame prior to the B frame and an I or P frame following to the B frame.

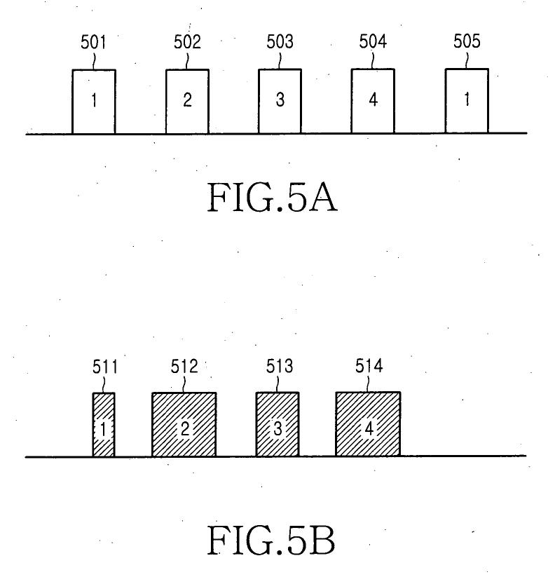

A group of continuous pictures, which is initiated with an I frame, is called GOP (group of pictures). FIG. 4 illustrates a GOP of MPEG pictures.

An I frame 401 can be decoded using its own value, and the value of the I frame 401 is used to decode a first P frame 404. B frames 402 and 403 located between the I frame 401 and the first P frame 404 are decoded using the I frame 401 and the first P frame 404. A second P frame 407 is decoded using the first P frame 404, and B frames 405 and 406 located between the first P frame 404 and the second P frame 407 are decoded using the first P frame 404 and the second P frame 407. A third P frame 410 is decoded using the second P frame 407, and B frames 408 and 409 located between the second P frame 407 and the third P frame 410 are decoded using the second P frame 407 and the third P frame 410.

When priorities are allocated to the frames based on their importance, in view of the above-mentioned decoding procedures or the size of data for realizing an image, the I frame has the highest priority, the P frame has a priority next to the I frame, and the B frame has the lowest priority.

The I frame, which is a basic frame, has the largest amount of data for realizing an image, while the P frame and B frame have only changed values based on an I frame. That is, upon reproducing an actual image, the B or P frames can represent an actual image with only a small amount of data by calculating simply the amount changed from an I frame. Therefore, although some of the B or P frames are dropped, the quality of motion picture is not greatly influenced.

The method of the present invention drops some data of motion picture data from the sync frame section, based on their importance. Thus, the region of a sync frame 11 is reduced so as to compensate for an exceeded region of an async frame 12. Therefore, the method of the present invention can transmit motion picture data without the occurrence of jitter in a synchronous Ethernet system, and without employing a hold scheme.

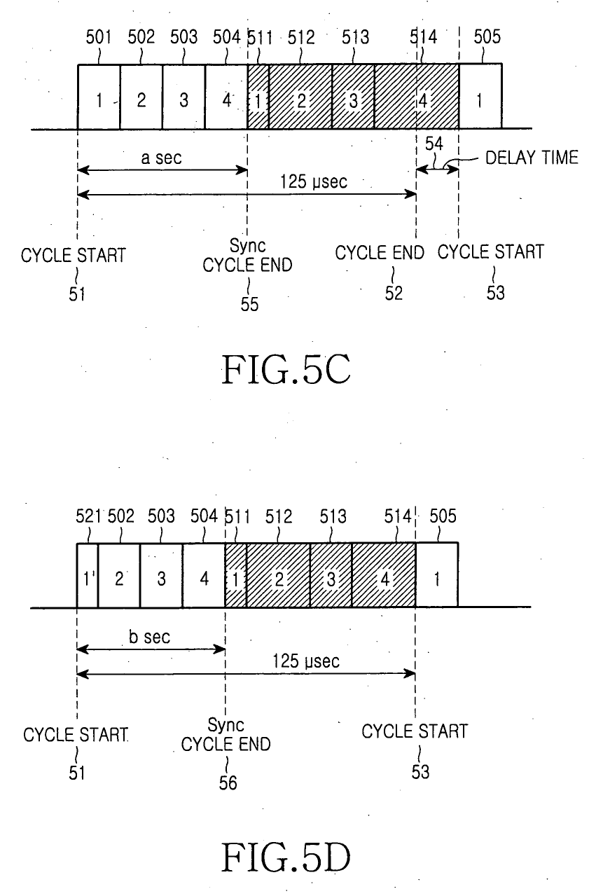

FIGS. 5A to 5D are views for explaining a data transmission scheme without jitter in a synchronous Ethernet system according to an embodiment of the present invention.

FIG. 5A shows sync frames 501 to 505 for transmission through the sync frame section 11. FIG. 5B shows async frames 511 to 514 for transmission through the async frame section 12. Herein, it is assumed that the sync frame section 11 of one cycle contains four sync frames (e.g. sync frames 501 to 504).

FIG. 5C is a view illustrating data transmission in an existing synchronous Ethernet system, in which jitter is incurred. The sync frames 501 to 504 are sequentially inserted into the sync frame section 11. Then the async frames are inserted into the async frame section 12. However, as shown in FIG. 5C, when the async frames are too large to be included within a cycle of 125 μsec, the start 53 of the next cycle is delayed.

That is, when 125 μsec elapses after the start 51 of a first cycle, the end 52 of the first cycle and the start 53 of the second cycle must be performed at the same time. However, in the case shown in FIG. 5C, the end of the first cycle is delayed by a delay time 54 due to the capacity of a fourth async frame 514, so that the start 53 of the second cycle is delayed. When the start of a cycle is not in harmony with a prescribed unit, as described above, jitter occurs. As noted above, the prior art employs the hold scheme of transmitting the fourth async frame 514 in the next cycle in order to prevent such jitter. Advantageously, the method of the present invention prevents the occurrence of jitter by reducing the size of the sync frame section 11, which has been set as a predetermined size in the prior art.

That is, according to the present invention, data having a size corresponding to the delay time 54 is dropped in the sync frame section 11. Thus, jitter is prevented.

FIG. 5D illustrates data transmission without jitter in a synchronous Ethernet system according to an embodiment of the present invention. The sync frames 501 to 504 are sequentially inserted into the sync frame section 11. Then the async frames are inserted into the async frame section 12. When the async frames are too large to be included within a cycle of 125 μsec, as shown in FIG. 5D, sync frame #1 501 is converted into sync frame #1′ 521 by dropping data by an amount corresponding to the delay time 54. In this manner, data can be transmitted without loss of bandwidth while the degradation of quality of a motion picture is minimized.

Although this embodiment shows a case of converting only sync frame #1 501, all sync frames including sync frame #1 501 can be converted. Thus, it is easy to cope with delay time having various lengths.

Data is inserted as a video stream structure into a sync frame. For example, such a video stream structure is constructed as a sequence having a unit of GOP, and I, P, B frames can be distinguished from each other in a picture block included in each GOP. Accordingly, the data can be inserted into the sync frame with P and/or B frames dropped, so that it is possible to convert the sync frames as described above.

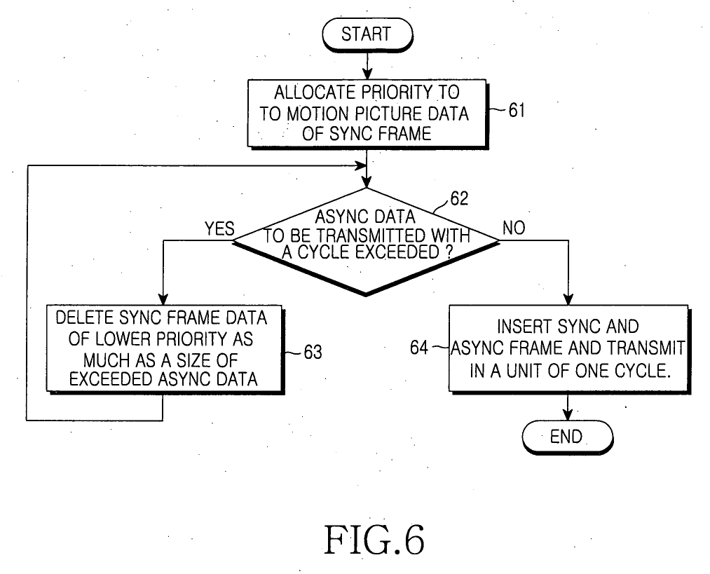

FIG. 6 is a flowchart illustrating a method for transmitting data without jitter in a synchronous Ethernet system according to an embodiment of the present invention.

First, a priority is allocated to each motion picture data of a sync frame in step 61. Herein, the motion picture data of a sync frame includes an I frame, a P frame, and a B frame. Typically, priorities are allocated in the order of I frame, P frame, and B frame.

In step 62, it is determined if async data to be transmitted in one cycle exceeds the start position of the next cycle, which is performed to check whether jitter occurs in the current status.

When it is determined as a result of step 62 that the async data for transmission in one cycle exceeds the start position of the next cycle, sync data is dropped in relation to the size of exceeded async data, e.g. similarly sized data. Then, step 62 is performed (step 63). In this case, the dropped sync data are data of sync frames having lower priorities.

In contrast, when it is determined as a result of step 62 that the async data for transmission in one cycle does not exceed the start position of the next cycle, sync frames and async frames are inserted into the relevant cycle and then are transmitted (step 64).

According to the present invention as described above, priorities are allocated to an I frame, a B frame, and a P frame. These are a basic unit of motion picture data included in a sync region, in a synchronous Ethernet system. The transmission occurs with some frames dropped according to their priorities when jitter may occur. Therefore, according to the present invention, it is possible to transmit data without loss of bandwidth as well as without jitter.

The method according to the present invention can be realized by a program and can be stored in a recording medium (such as a CD ROM, a RAM, a floppy disk, a hard disk, a magneto-optical disk, etc.) in a format that can be read by a computer.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A method for transmitting data in a synchronous Ethernet system having a sync frame section and an async frame section, the method comprising the steps of:
a) allocating a priority to motion picture data for transmission in the sync frame section;
b) determining if a size of the data of all frames for transmission in one cycle exceeds a predetermined length;
c) dropping motion picture data having a lower priority if the size of the data to be transmitted exceeds the predetermined length; and
d) transmitting the data in one cycle unit.

2. The method as claimed in claim 1, wherein the dropped motion picture data corresponds to the size of the data exceeding the predetermined length.

3. The method as claimed in claim 2, wherein transmitting the data occurs when the size of the data to be transmitted does not exceed the predetermined length.

4. The method as claimed in claim 1, wherein steps (b) and (c) are repeated until the size of the data to be transmitted does not exceed the predetermined length.

5. The method as claimed in claim 1, wherein the motion picture data includes an intra-coded frame (I frame), a predictive-coded frame (P frame), and a bi-directional-coded frame (B frame).

6. The method as claimed in claim 5, wherein priorities are allocated to the frames based on importance of each fame.

7. The method as claimed in claim 6, wherein a highest priority is allocated to the I frame, a priority next to the I frame is allocated to the P frame, and a lowest priority is allocated to the B frame.

8. A computer-readable medium including code for transmitting data in a synchronous Ethernet system having a sync frame section and an async frame section, the computer-readable medium comprising:
code for allocating a priority to data of all frames for transmission in the sync frame section;
code for determining if a size of the data of all frames for transmission in one cycle exceeds a predetermined length;
code for dropping motion picture data having a lower priority if the size of the data to be transmitted exceeds the predetermined length; and
code for transmitting the data in one cycle unit.

9. A method for encoding data in a synchronous Ethernet system having a sync frame section and an async frame section, the method comprising the steps of:
allocating a priority to data of all frames for transmission in the sync frame section;
determining if a size of the data of all frames for transmission in one cycle exceeds a predetermined length; and
dropping motion picture data having a lower priority if the size of the data to be transmitted exceeds the predetermined length.
